(19) United States
(12) Patent Application Publication
(10) Pub. No.: US 2016/0058260 A1
(43) Pub. Date: Mar. 3, 2016

(54) Power Transfer In An Industrial Carpet Cleaner

(71) Applicant: Wayne Eric Boone, St Charles, IL (US)

(72) Inventor: Wayne Eric Boone, St Charles, IL (US)

(21) Appl. No.: 14/256,936

(22) Filed: Apr. 19, 2014

(51) Int. Cl. A47L 11/34; A47L 7/00; A47L 11/40; B60K 25/06

(52) U.S. Cl. CPC A47L 11/34; B60K 25/06; A47L 7/0023; A47L 11/4061; A47L 11/4086; A47L 11/4083

(57) ABSTRACT

A drive system for a mobile carpet cleaning apparatus that overcomes limitations of the prior art for powering a mobile carpet cleaning system in any Light, Medium or Heavy duty van or truck of Class 1 through Class 8, as classified by the Department of Transportation's Federal Highway Administration (FHWA), when the van or truck is a rear wheel drive vehicle. According to the invention, both the vacuum generator and the pressure generator of the carpet cleaning system are mechanically coupled to a power take-off output of a split shaft power take off (PTO) unit positioned between the host vehicle's power plant and rear differential.

### FIELD OF THE INVENTION

The present invention relates to drive devices and methods in mobile professional carpet and floor cleaning apparatuses, and in particular to drive devices and methods for transferring power from a primary power plant of a host vehicle to a carpet cleaning system mounted on the host vehicle.

### BACKGROUND OF THE INVENTION

Professional floor cleaning systems generally provide for the management of heat, vacuum, pressure, fresh and gray water, chemicals, and power to achieve the goal of efficient, thorough cleaning of different substrates, usually carpets but also hard flooring, linoleum and other substrates, in both residential and commercial establishments. Professional substrate cleaning systems are also utilized in the restoration industry for water extraction.

Of the many professional substrate cleaning systems available, a major segment are self-contained having a heat source, vacuum source, chemical delivery system, and water dispersion and extraction capabilities.

One type of professional substrate cleaning system includes its own dedicated power plant. These are commonly referred to as “slide-in” systems and install permanently in cargo vans, trailers and other commercial vehicles, but can also be mounted on portable, wheeled carts. Slide-in systems comprise a series of components designed and integrated into a package with an overall goal of performance, economy, reliability, safety, useful life, serviceability, and sized to fit in various commercial vehicles. An example of one such slide-in system is shown and described in U.S. Pat. No. 7,208,050 “DIRECT DRIVE INDUSTRIAL CARPET CLEANER” issued Apr. 24, 2007, which is incorporated herein by reference. FIG. 1 of U.S. Pat. No. 7,208,050 schematically illustrates a state-of-the-art industrial slide-in substrate cleaning system for carpets, hard flooring, linoleum and other substrates, one well-known example of which is the self-contained, gas-powered, truck-mounted model CTS-450 that is commercially available from Hydramaster Corporation, Mukilteo, Wash.

Other professional substrate cleaning systems rely on drive devices and methods for transferring power from a primary power plant of the host vehicle to power the carpet cleaning system. As background, in the United States, commercial truck classification is determined based on the vehicle's gross vehicle weight rating (GVWR).

The Department of Transportation's Federal Highway Administration (FHWA) breaks commercial trucks into Classes from 1-8 on the basis of GVWR ranges. Smaller so called Light duty vehicles are classified by the FHWA in Class 1 through Class 3 with gross vehicle weight rating (GVWR) ranges from 0-14000 lb (0-6350 kg). Class 4 and larger vehicles through Class 8, so called Medium and Heavy duty trucks, as classified by the FHWA are trucks having gross vehicle weight rating (GVWR) ranges from 14001-33000 lb (6531-14969 kg) and above. Class 8 includes most tractor trailer trucks. The United States Environmental Protection Agency has a separate system of emissions classifications for trucks. The United States Census Bureau also assigned classifications in its now-discontinued Vehicle Inventory and Use Survey (VIUS) (formerly Truck Inventory and Use Survey (TIUS)).

Significantly, in so called Medium and Heavy duty trucks, Class 4 and larger vehicles through Class 8, the vehicle transmission often has provision for mounting a power take off (PTO) unit. However, currently only vehicles having Diesel engines offer the transmission with the mounting a power take off (PTO) unit. In rare instances the transmission may have two apertures for connecting a PTO unit, one on each of the left and right sides of the transmission, although most transmissions may have only one such PTO mounting aperture. At least one manufacturer, Eaton Corporation, offers a transmission having a PTO mounting aperture on its bottom, which is offset to the left side, and some automatic transmissions available from Allison Transmission, Inc. have a PTO mounting aperture at the top. The transmissions having only a single PTO mounting aperture severely limit the number of components that can be driven by the host vehicle's primary power plant.

The PTO must be purchased separately and care is required to match the physical interface of the transmission with a compatible PTO unit. PTO unit suppliers typically require details of the make, model and even serial number of the transmission on which the PTO unit is to be mounted. Care is also needed to ensure that the truck includes physical space around the transmission that allows for installation of the PTO unit. When mounted on the vehicle transmission, the PTO unit is engaged and disengaged using the host vehicle's main transmission clutch and a remote control mechanism which operates on the PTO unit itself. Typically an air valve is used to engage the PTO unit, but a mechanical linkage, electric or hydraulic mechanism are also optional means for engaging the PTO unit.

PTO units are rated according to the continuous and intermittent torque that can be applied through them, and different models of PTO unit offer different “PTO shaft rotation to engine RPM” ratios. In the majority of cases, the PTO unit connects directly to a hydraulic pump, which allows for transmission of mechanical force through the hydraulic fluid system to any location around the vehicle where a hydraulic motor converts the fluid force back into rotary or linear mechanical force.

Inside the host vehicle's transmission, the exact point along the gear train where the power is taken off determines whether the PTO unit can be run independently of vehicle travel, i.e., ground speed. Early PTO units were often taken off the main output shaft of the transmission, whereby the vehicle had to be “in gear” in order to operate the PTO unit. Later this situation was improved by so-called live PTO (LPTO) unit designs, which allow control of the PTO rotation independently of the tractor motion. This is an advantage when the load driven by the PTO unit requires the tractor motion to slow or stop running to allow the PTO unit driven equipment to catch up. The LPTO also allows operations where the tractor remains parked, such as silo-filling or unloading a manure spreader to a pile or lagoon rather than across a field. Most current PTO units are live. In modern tractors, the LPTO unit is often controlled by push-button or selector switch, which increases safety of operators who need to get close to the PTO unit output shaft.

FIG. 1 and FIG. 2 together illustrate one example of a truck 1 of Class 4 or larger, i.e. so called Medium and Heavy duty trucks, having a transmission 3 coupled to the power plant 5 of the host vehicle. Transmission 3 is manufactured with a power take off (PTO) mounting aperture 7. A conventional power take off (PTO) unit 9 is coupled to PTO mounting aperture 7 of transmission 3. A typical professional substrate cleaning system 11 is installed in a cargo area 13 of truck 1, according to the prior art. Professional substrate cleaning system 11 includes a drive system 15 for driving a vacuum blower 17 that is the vacuum source for removing soiled water from the cleaned substrate, either carpet or other flooring, and an interface assembly 19 for transmitting power from the power plant to vacuum blower 17. Here, power transmission interface assembly 19 is pulley and belt system coupled to an output of PTO) unit 9. A water pump or air compressor 9 is driven by the power plant 5 via V-belt interface assembly 19 (shown) for pressurizing fresh water from a source such as a water tank 21. One or more heat exchangers and associated plumbing 23 are coupled for receiving the pressurized fresh water and heating it. A recovery tank 25 is provided wherein gray water is stored after removal from the cleaned surface. A high pressure solution hose 27 is provided for delivering pressurized, hot water/chemical solution from the machine via a wand or power head to the substrate to be cleaned, usually a carpet or hard flooring. A wand or power head 29 is coupled to the high pressure solution hose 27 for receiving and dispersing the pressurized hot water/chemical cleaning solution to the carpet. The wand or power head 29 is the only “portable” part of truck-mount slide-in professional carpet cleaning systems in that it is removed from the vehicle and carried to the carpet or other substrate to be cleaned, and it is the only equipment that makes physical contact with the carpet to be cleaned. A vacuum hose 31 is coupled to the wand or power head 29 for recovering the soiled water-based chemical cleaning solution from the cleaned surface via the wand or power head 29 and delivering it to recovery tank 25.

Unfortunately, these Class 4 through Class 8 trucks are large and difficult to maneuver on city streets. Also, they are currently only offered with Diesel engines. As discussed above, the transmissions of these classes of trucks are typically offered with only a single PTO aperture, which severely limits the number of components that can be driven by a PTO.

As discussed, only so called medium and heavy duty trucks, Class 4 and larger vehicles, offer provision for mounting a power take off (PTO) unit on the vehicle transmission. Thus, smaller so called Light duty vehicles of Class 1 through Class 3 do not have the option of transferring power through a PTO unit from the vehicle transmission. When a professional substrate cleaning system not of the slide-in variety shown and described in U.S. Pat. No. 7,208,050 (above) and not having an own dedicated power plant, power must be transferred directly from the primary power plant of the host vehicle.

FIG. 3 illustrates a conventional cleaning system 33 installed in a cargo area 35 of such a Light duty van or truck 37 must rely on a drive system 39, such as a V-belt (shown) or direct drive, to transfer power directly from the primary power plant 41 of the host vehicle 37, according to the prior art. Conventional cleaning system 33 includes a vacuum blower 43 that is the vacuum source for removing soiled water from the cleaned substrate, either carpet or other flooring. Drive system 39 is coupled through an electric clutch or other releasable coupler 45 to the primary power plant 41 of host vehicle 37 for transmitting power to vacuum blower 43. An intake hose 47 is coupled to a source of fresh water, and a high pressure water pump or air compressor 49 driven by vehicle power plant 41 via drive system 39 for pressurizing the fresh water. One or more heat exchangers and associated plumbing 51 is coupled for receiving the pressurized fresh water and heating it. A waste water recovery tank 53 is provided wherein gray water is stored after removal from the cleaned surface. A high pressure solution hose 55 is provided for delivering pressurized, hot water/chemical solution from the machine via a cleaning tool 57 to the substrate to be cleaned, usually a carpet or hard flooring, and a chemical container 59 or other chemical system is coupled for delivering a stream of cleaning chemical into hot water as it enters the high-pressure solution hose 55. A wand or power head or other cleaning tool 57 is coupled to the high pressure solution hose 55 for receiving and dispersing the pressurized hot water/chemical cleaning solution to the carpet. The cleaning tool 57 is the only “portable” part of truck-mount slide-in professional carpet cleaning systems in that it is removed from the vehicle and carried to the carpet or other substrate to be cleaned, and it is the only equipment that makes physical contact with the carpet to be cleaned. A vacuum hose 61 is coupled to the cleaning tool 57 for recovering the soiled water-based chemical cleaning solution from the cleaned surface via the cleaning tool 57 and delivering it to the recovery tank 53.

FIG. 4 illustrates the conventional drive system 39 for transferring power directly from the primary power plant 41 of the host vehicle 37, according to the prior art. Here, a drive shaft assembly 63 extends directly from the front of the host vehicle's primary power plant 41 to the conventional cleaning system 33 installed in cargo area 35 of a Light duty van or truck 37. The front of drive shaft assembly 63 is supported by a motor mount 65, which requires a spacer 67 for mounting to the vehicle engine 41. A front drive shaft mount assembly 69 is mounted on the front of the drive shaft assembly 63. A balancer 71 is mounted to the front of the vehicle engine 41 with a spacer 73 between it and a belt pulley 75. A front end idler assembly 77 is also mounted to the front of the vehicle engine 41. A belt 79 is coupled between the pulley 75 on the front of the vehicle engine 41 and another belt pulley 81 on the front end of the drive shaft assembly 63. A rear drive shaft mount assembly 83 supports the rear end of the drive shaft assembly 63. Additional belt pulleys 85 and 87 are mounted on the rear end of the drive shaft assembly 63 with a fastener 89. A means, such as electric clutch 45, is provided for controlling activation of the conventional belt-and-pulley drive system 39.

Thus, any known conventional professional substrate cleaning systems installed in a vehicle must either include own dedicated power plant as shown and described in U.S. Pat. No. 7,208,050, or rely on drive devices and methods for transferring power from a primary power plant of the host vehicle to power the carpet cleaning system, as shown and described herein. So called Medium and Heavy duty trucks, Class 4 and larger vehicles through Class 8, have access to one, rarely two, PTO mounting aperture on the transmission of the host vehicle power plant. These Medium and Heavy duty trucks suffer the multiple drawbacks that they are large, which makes them difficult to maneuver on city streets, they are currently available only with Diesel engines, and their transmissions usually only have a single PTO mounting aperture, all of which limit their use for carrying professional substrate cleaning systems. So called Light duty trucks, Class 1 through Class 3, suffer from not having any PTO mounting aperture on the transmission so that utilization of a conventional PTO unit for transferring power from the host vehicle power plant to the cleaning system is not available. Rather, professional substrate cleaning systems carried in a Light duty truck must rely on transferring power from the front of the vehicle engine, whether through a complex and unwieldy arrangement of pulleys and belts between the front of the host vehicle power plant, or by driving a hydraulic pump through a standard power take off pulley mounted on the front of the vehicle engine, as disclosed by Bates in U.S. Pat. No. 4,109,340, which is incorporated herein by reference.

Unfortunately, the prior art fails to provide a simple, efficient and reliable mechanism for utilizing the primary power plant of the host vehicle to power a mobile carpet cleaning system, at least in Light duty vans and trucks in Class 1 through Class 3.

### SUMMARY OF THE INVENTION

The present invention is a present invention is a drive system for a mobile carpet cleaning apparatus that overcomes limitations of the prior art for powering a mobile carpet cleaning system in any Light, Medium or Heavy duty van or truck of Class 1 through Class 8, as classified by the FHWA.

According to one aspect of the invention, the mobile carpet cleaning apparatus includes a rear wheel drive mobile vehicle having an on-board power plant adjacent to a forward portion of the vehicle and mechanically coupled through a transmission to a differential adjacent to a rearward portion of the vehicle. A split shaft power take off unit is positioned between the transmission and the differential, with an input of the split shaft power take off unit being mechanically coupled through a forward drive shaft to the transmission, and a straight-through output of the split shaft power take off unit being mechanically coupled through a rear drive shaft to the differential. A carpet cleaner system is positioned in the vehicle. The carpet cleaner system includes a conduit for receiving fresh water from a source thereof, and a pressure generator coupled for pressurizing the fresh water. A heater is coupled for receiving and heating the pressurized fresh water, and a high pressure solution hose is coupled for receiving the heated and pressurized fresh water. A chemical source is coupled for delivering a stream of cleaning chemical into the heated and pressurized fresh water within the high-pressure solution hose for aiding in cleaning the target substrate. A carpet cleaner device, such as a wand or power head or other cleaning tool, is coupled to the high pressure solution hose for receiving and dispersing the pressurized hot water and chemical cleaning solution to a target substrate. A recovery tank is provided for receiving soiled water and chemical cleaning solution. A vacuum hose is coupled to the carpet cleaner device for recovering the soiled water and chemical cleaning solution from the substrate via the carpet cleaner device and delivering the soiled cleaning solution to the recovery tank. A vacuum generator is coupled to produce a vacuum in the vacuum hose for recovering the soiled cleaning solution from the substrate. According to the invention, both the vacuum generator and the pressure generator are mechanically coupled to a power take-off output of the split shaft power take off unit.

According to another aspect of the invention, the on-board power plant of the host vehicle is either a Diesel engine or a gasoline-powered engine.

According to another aspect of the invention, the vacuum generator and the pressure generator are mechanically coupled to the power take-off output of the split shaft power take off unit via a belt-and-pulley drive system. For example, a drive pulley is coupled to the power take-off output of the split shaft power take off unit. Optionally, an auxiliary drive shaft is coupled between the drive pulley and the power take-off output of the split shaft power take off unit. When an auxiliary drive shaft is coupled between the drive pulley and the power take-off output of the split shaft power take off unit, a drive shaft mount assembly is optionally coupled for supporting the auxiliary drive shaft.

According to another aspect of the invention, a control mechanism is coupled to control engagement of the power take-off output of the split shaft power take off unit.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 and FIG. 2 illustrate one prior art example of a truck of Class 4 or larger, i.e. so called Medium and Heavy duty trucks, utilizing a conventional power take off (PTO) unit coupled to a power take off (PTO) mounting aperture of the vehicle transmission for transferring power from the power plant of the host vehicle to a typical professional substrate cleaning system installed in a cargo area of the truck, wherein FIG. 1 is a top view, and FIG. 2 is a side view;

FIG. 3 illustrates a conventional cleaning system of the prior art installed in a cargo area of a so called Light duty vehicle of Class 1 through Class 3 that does not have the option of transferring power through a PTO unit from the vehicle transmission, but instead is illustrated as utilizing a V-belt (shown) or direct drive system to transfer power directly from the primary power plant of the host vehicle to a typical professional substrate cleaning system installed in a cargo area of the truck;

FIG. 4 illustrates the conventional drive system of the prior art for transferring power directly from the primary power plant of the host vehicle to a typical professional substrate cleaning system installed in a cargo area in a Light duty van or truck in Class 1 through Class 3;

FIG. 5 and FIG. 6 illustrate one embodiment of the novel drive devices and methods of the invention for transferring power from the primary power plant of any host vehicle having rear wheel drive to a carpet cleaning system mounted on the host vehicle when the host vehicle is any Light, Medium or Heavy duty van or truck of Class 1 through Class 8, as classified by the FHWA, wherein FIG. 5 is a side view of the cleaning system, and FIG. 6 is a detail view of this embodiment of the novel drive devices and methods of the invention; and

FIG. 7 and FIG. 8 illustrate an alternative embodiment of the novel drive devices and methods of the invention for transferring power from the primary power plant of any host vehicle having rear wheel drive to a carpet cleaning system mounted on the host vehicle when the host vehicle is any Light, Medium or Heavy duty van or truck of Class 1 through Class 8, as classified by the FHWA, wherein FIG. 7 is a side view of the cleaning system embodying the an alternative embodiment of the invention, and FIG. 8 is a detail view of this alternative embodiment of the novel drive devices and methods of the invention.

### DETAILED DESCRIPTION OF PREFERRED EMBODIMENT

As required, a detailed illustrative embodiment of the present novel drive devices and methods for transferring power from a primary power plant of a host vehicle to a mobile carpet cleaning system is disclosed herein. However, techniques, systems and operating structures in accordance with the present protective enclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of an illustrative embodiment (as well as some alternative embodiments) of the present invention.

In the Figures, like numerals indicate like elements.

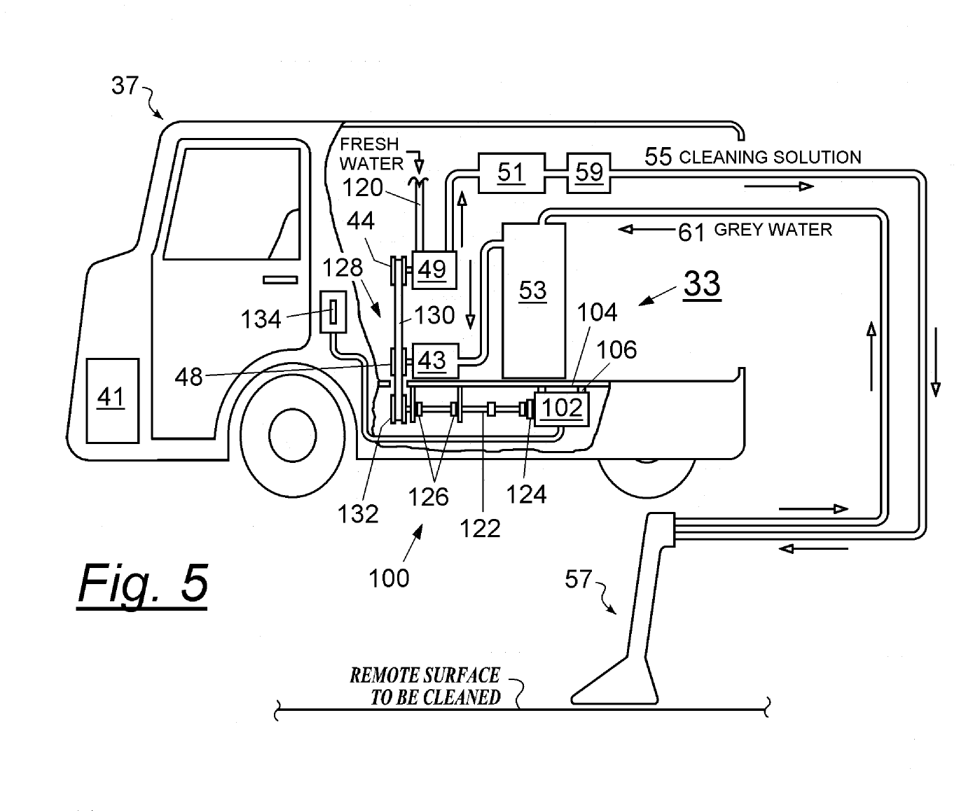

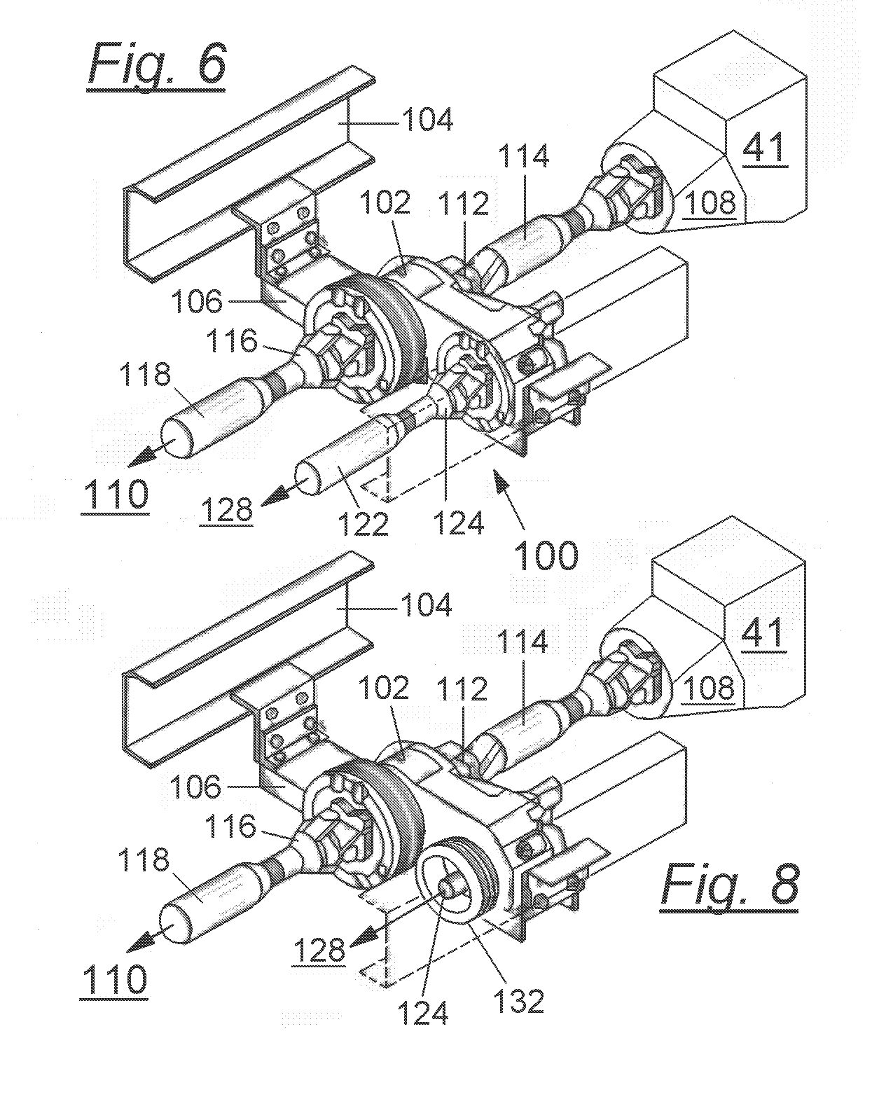

FIG. 5 and FIG. 6 illustrate one embodiment of the invention for novel drive devices 100 and methods for transferring power from the primary power plant 41 of a host vehicle 37 to a carpet cleaning system 33 mounted on the host vehicle 37 when the host vehicle 37 is any Light, Medium or Heavy duty van or truck of Class 1 through Class 8, as classified by the FHWA, having rear wheel drive. According to this embodiment of the invention, novel drive devices 100 and methods include a split shaft power take off (PTO) unit 102 is secured to the host vehicle's frame or other structure 104 by a support structure 106 in position between the transmission 108 and rear differential 110. An input 112 of the split shaft PTO unit 102 is mechanically coupled through a forward drive shaft 114 to the transmission 108, and a straight-through output 116 of the split shaft PTO unit 102 is mechanically coupled through a rear drive shaft 118 to the rear drive differential 110.

A carpet cleaner system 33 includes a conduit 120 for receiving fresh water from a source thereof. A pressure generator 49, such as a high pressure water pump or air compressor, is coupled for receiving and pressurizing the fresh water. A heater 51, such as one or more heat exchangers and associated plumbing, is coupled to pressure generator 49 for receiving the pressurized fresh water and heating it. A high pressure solution hose 55 is coupled for receiving the heated and pressurized fresh water. A chemical source 59, such as a chemical container or other chemical system, is coupled for delivering a stream of cleaning chemical into the heated and pressurized fresh water as it enters the high-pressure solution hose 55. A wand or power head or other substrate cleaning tool 57 is coupled to the high pressure solution hose 55 for receiving and dispersing the pressurized hot water and chemical cleaning solution to a target substrate to be cleaned. A recovery tank 53 is included for receiving soiled water and chemical cleaning solution. A vacuum hose 61 is coupled to the cleaning tool 57 for recovering the soiled water and chemical cleaning solution from the substrate via the cleaning tool 57 and delivering the soiled cleaning solution to the recovery tank 53. A vacuum generator or blower 43 is coupled to produce a vacuum in the vacuum hose 61 for recovering the soiled cleaning solution from the substrate. According to the invention, the vacuum generator 43 and the pressure generator 49 are mechanically coupled to power take-off output 124 of the split shaft PTO unit 102.

By example and without limitation, split shaft PTO unit 102 is illustrated as being secured to the vehicle's frame or other structure 104 by support structure 106. One end of an auxiliary driveline 122 is coupled a PTO power take-off aperture 124 of split shaft PTO unit 102, with an opposite end of the auxiliary driveline 122 is coupled drive the pressure generator 49 and vacuum generator 43. As required by design, auxiliary driveline 122 may be supported in one or more places by a drive shaft mount assembly 126 such as but not limited to one or more (two shown) pillow block bearings suspended from the host vehicle's frame or other structure 104. According to one embodiment, auxiliary driveline 122 is coupled drive the pressure generator 49 and vacuum generator 43 through a drive system 128, such as a belt-and-pulley system (shown) or direct drive, to transfer power directly from the split shaft PTO unit 102, which is driven by the primary power plant 41 of the host vehicle 37 through forward drive shaft 114. For example, when drive system 128 is a belt-and-pulley system (shown), a drive belt 130 is coupled between a drive pulley 132 coupled to auxiliary driveline 122 at power take-off output 124 of split shaft PTO unit 102 and respective input pulleys 44 and 48 pressure generator 49 and vacuum generator 43.

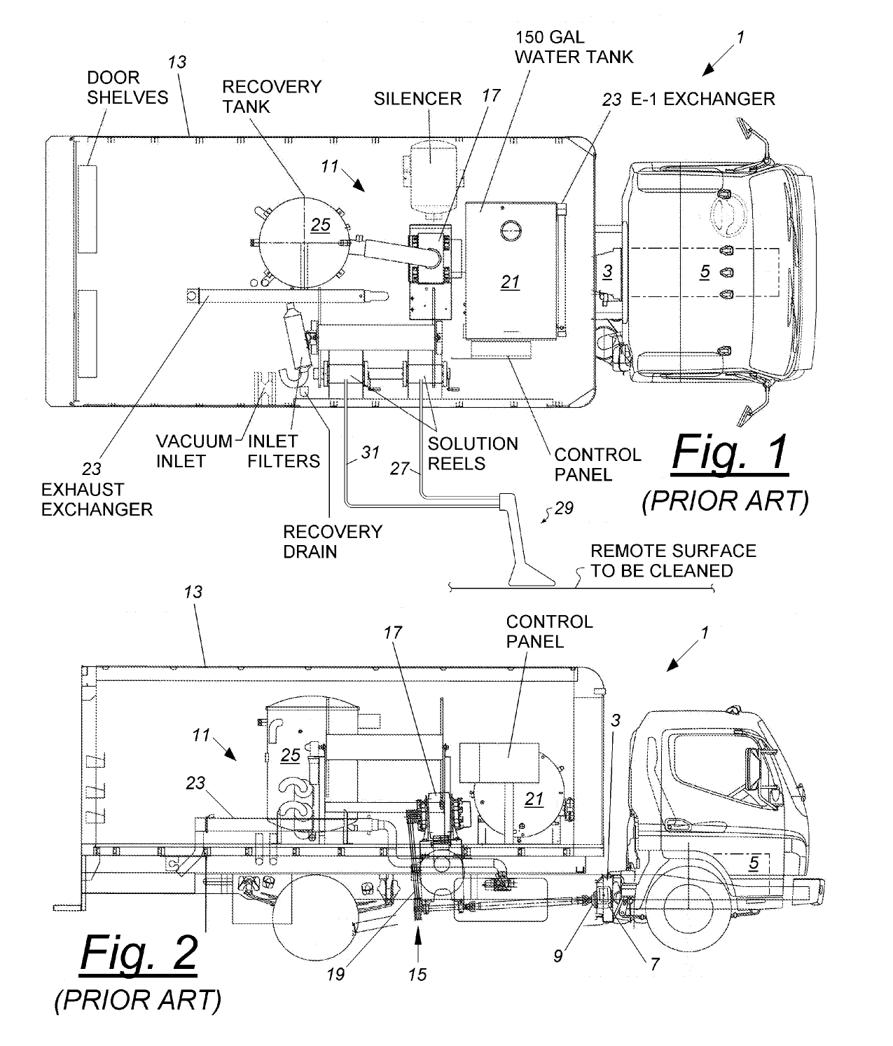

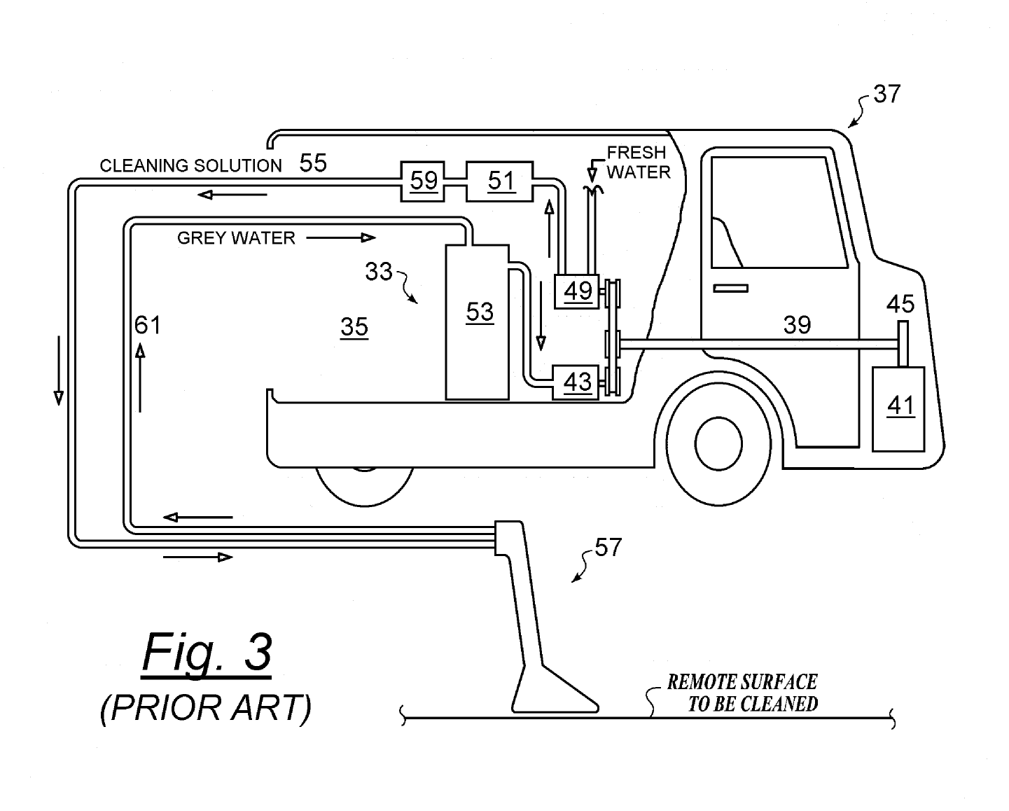

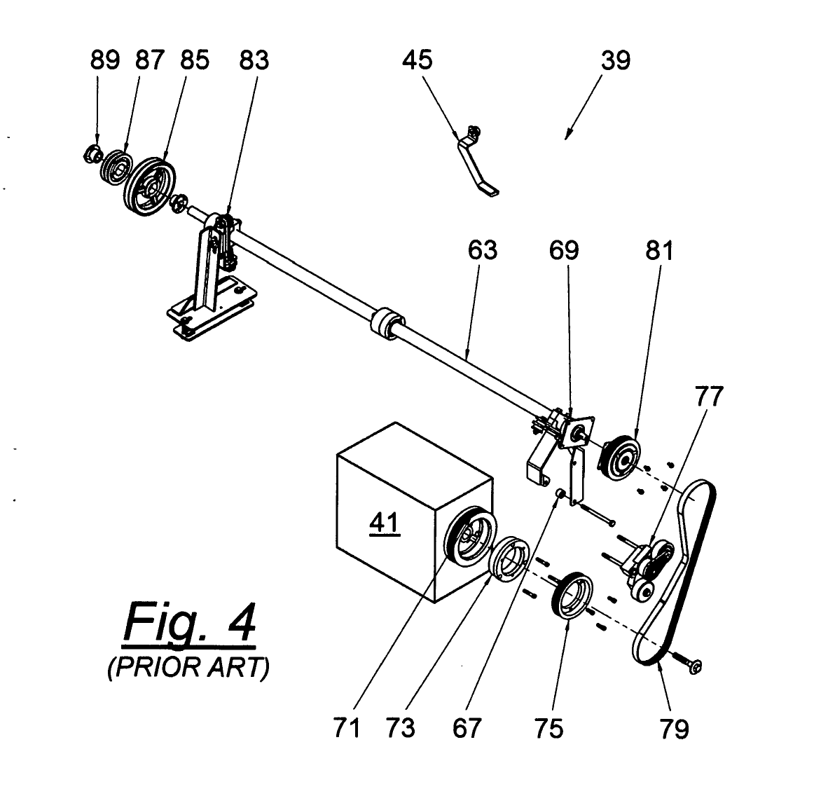

Optionally, the split shaft PTO unit 102 has multiple PTO openings or apertures 124, whereby the pressure generator 49 and vacuum generator 43 driven separately. Multiple PTO apertures 124 provided by split shaft PTO 102 are available where none exist on the host vehicle's main transmission 3 (FIGS. 1 and 2) or where space limitations restrict access to the transmission's PTO mounting aperture 7. Split shaft PTO 102 is designed to use the host vehicle's driveshaft as its input and provides multiple PTO outputs 124 for auxiliary power equipment.

Split shaft PTO unit 102 is engaged via a control mechanism 134, such as either air-shift or heavy duty push/pull cable, coupled to control engagement of split shaft PTO 102. When engaged, the host vehicle's main driveshaft, i.e., forward drive shaft 114, is disconnected from the rear differential 110.

FIG. 6 is a detail view of one embodiment of the invention for novel drive device 100 and method, as described herein, for transferring power from the primary power plant 41 of a host vehicle 37 to a carpet cleaning system 33 in any Light, Medium or Heavy duty host van or truck 37 of Class 1 through Class 8, as classified by the FHWA, having rear wheel drive.

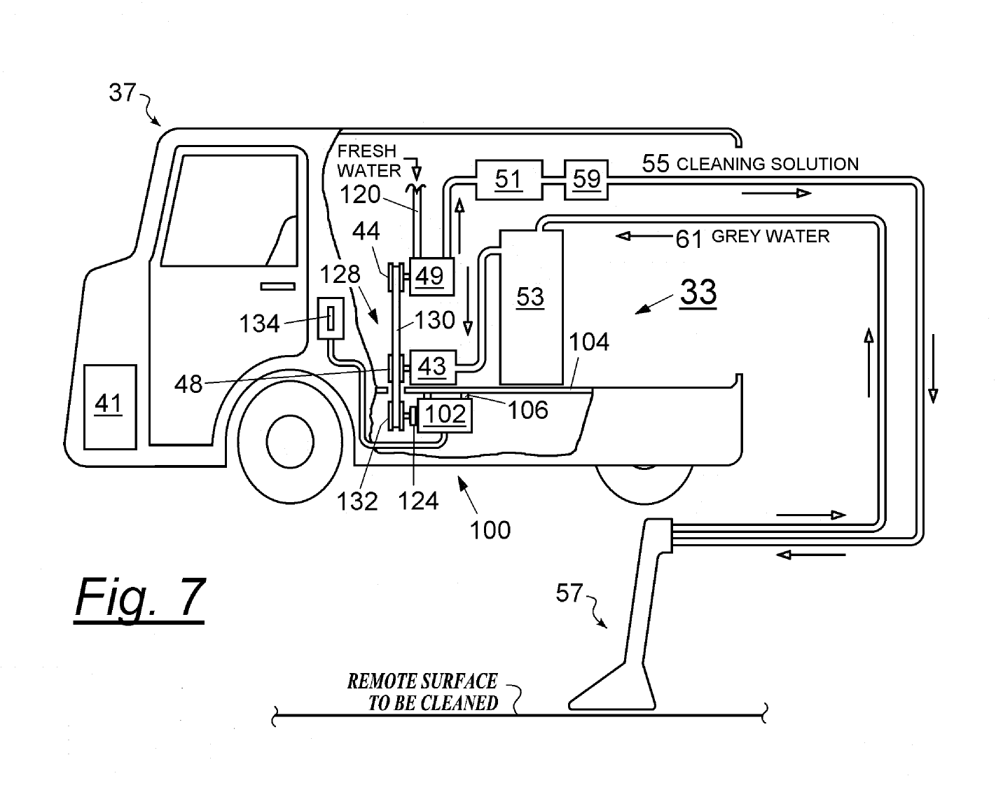

FIG. 7 and FIG. 8 illustrate an alternative embodiment of the invention for novel drive devices 100 and methods for transferring power from the primary power plant 41 of a host vehicle 37 to carpet cleaning system 33 mounted on the host vehicle 37 when the host vehicle 37 is any Light, Medium or Heavy duty van or truck of Class 1 through Class 8, as classified by the FHWA, having rear wheel drive. According to this embodiment of the invention, novel drive devices 100 and methods include split shaft power take off (PTO) unit 102 that is secured to the host vehicle's frame or other structure 104 by support structure 106 in position between the host vehicle's transmission 108 and rear differential 110. Input 112 of split shaft PTO unit 102 is mechanically coupled through forward drive shaft 114 to the transmission 108, and straight-through output 116 of the split shaft PTO unit 102 is mechanically coupled through rear drive shaft 118 to rear drive differential 110.

In FIG. 7 carpet cleaner system 33 includes conduit 120 for receiving fresh water from a source thereof. Pressure generator 49, such as a high pressure water pump or air compressor, is coupled for receiving and pressurizing the fresh water. Heater 51, such as one or more heat exchangers and associated plumbing, is coupled to pressure generator 49 for receiving the pressurized fresh water and heating it. High pressure solution hose 55 is coupled for receiving the heated and pressurized fresh water. Chemical source 59, such as a chemical container or other chemical system, is coupled for delivering a stream of cleaning chemical into the heated and pressurized fresh water as it enters the high-pressure solution hose 55. Wand or power head or other substrate cleaning tool 57 is coupled to high pressure solution hose 55 for receiving and dispersing the pressurized hot water and chemical cleaning solution to a target substrate to be cleaned. Recovery tank 53 is included for receiving soiled water and chemical cleaning solution. Vacuum hose 61 is coupled to cleaning tool 57 for recovering the soiled water and chemical cleaning solution from the substrate via cleaning tool 57 and delivering the soiled cleaning solution to recovery tank 53. Vacuum generator or blower 43 is coupled to produce a vacuum in vacuum hose 61 for recovering the soiled cleaning solution from the substrate. According to the invention, vacuum generator 43 and pressure generator 49 are mechanically coupled to power take-off output 124 of the split shaft PTO unit 102.

By example and without limitation, split shaft PTO unit 102 is illustrated as being secured to the vehicle's frame or other structure 104 by support structure 106. Split shaft PTO unit 102 is positioned adjacent to vacuum generator 43 and pressure generator 49. Here, drive system 128 is a belt-and-pulley system for transferring power directly from the split shaft PTO unit 102, which is driven by the primary power plant 41 of the host vehicle 37 through forward drive shaft 114. Drive pulley 132 of drive system 128 is substantially directly coupled to power take-off output 124 of split shaft PTO unit 102, whereby auxiliary driveline 122 and support by a drive shaft mount assembly 126 are eliminated. Drive belt 130 couples drive pulley 132 to respective input pulleys 44 and 48 pressure generator 49 and vacuum generator 43.

Split shaft PTO unit 102 is engaged via control mechanism 134, such as either air-shift or heavy duty push/pull cable, coupled to control engagement of split shaft PTO 102. When engaged, the host vehicle's main driveshaft, i.e., forward drive shaft 114, is disconnected from the rear differential 110.

FIG. 8 is a detail view of alternative embodiment of the invention for novel drive device 100 and method, as described herein, for transferring power from the primary power plant 41 of a host vehicle 37 to a carpet cleaning system 33 in any Light, Medium or Heavy duty host van or truck 37 of Class 1 through Class 8, as classified by the FHWA, having rear wheel drive.

While the preferred and additional alternative embodiments of the invention have been illustrated and described, it will be appreciated that various changes can be made therein without departing from the spirit and scope of the invention. Therefore, it will be appreciated that various changes can be made therein without departing from the spirit and scope of the invention. Accordingly, the inventor makes the following claims.

What is claimed is:

1. A mobile carpet cleaning apparatus, comprising:
a mobile vehicle comprising an on-board power plant mechanically coupled through a transmission to a differential;
a split shaft power take off unit positioned between the transmission and the differential, an input of the split shaft power take off unit being mechanically coupled through a first drive shaft to the transmission, and a straight-through output of the split shaft power take off unit being mechanically coupled through a second drive shaft to the differential;
a carpet cleaner system positioned in the vehicle, the carpet cleaner system comprising:
a conduit for receiving fresh water from a source thereof;
a pressure generator coupled for pressurizing the fresh water;
a heater coupled for receiving and heating the pressurized fresh water;
a high pressure solution hose coupled for receiving the heated and pressurized fresh water;
a carpet cleaner device coupled to the high pressure solution hose for receiving and dispersing the pressurized hot water and chemical cleaning solution to a target substrate;
a recovery tank for receiving soiled water and chemical cleaning solution;
a vacuum hose coupled to the carpet cleaner device for recovering the soiled water and chemical cleaning solution from the substrate via the carpet cleaner device and delivering the soiled cleaning solution to the recovery tank;
a vacuum generator coupled to produce a vacuum in the vacuum hose for recovering the soiled cleaning solution from the substrate; and
wherein the vacuum generator and the pressure generator are mechanically coupled to a power take-off output of the split shaft power take off unit.

2. The apparatus of claim 1, further comprising a chemical source coupled for delivering a stream of cleaning chemical into the heated and pressurized fresh water.

3. The apparatus of claim 1, wherein the on-board power plant further comprises a Diesel engine.

4. The apparatus of claim 1, wherein the on-board power plant further comprises a gasoline engine.

5. The apparatus of claim 1, wherein the vacuum generator and the pressure generator are mechanically coupled to the power take-off output of the split shaft power take off unit via a belt-and-pulley drive system.

6. The apparatus of claim 5, wherein a drive pulley is coupled to the power take-off output of the split shaft power take off unit.

7. The apparatus of claim 6, further comprising an auxiliary drive shaft coupled between the drive pulley and the power take-off output of the split shaft power take off unit.

8. The apparatus of claim 7, further comprising a drive shaft mount assembly coupled for supporting the auxiliary drive shaft.

9. The apparatus of claim 1, further comprising a control mechanism coupled to control engagement of the power take-off output of the split shaft power take off unit.

10. A mobile carpet cleaning apparatus, comprising:
a mobile vehicle comprising an on-board power plant mechanically coupled to a transmission, and the transmission spaced away from and mechanically coupled to a differential;
a split shaft power take off unit positioned between the transmission and the differential, an input of the split shaft power take off unit being mechanically coupled through a input drive shaft to the transmission, and a straight-through output of the split shaft power take off unit being mechanically coupled through an output drive shaft to the differential;
a carpet cleaner system positioned in the vehicle, the carpet cleaner system comprising:
a conduit for receiving fresh water from a source thereof;
a pressure generator coupled for pressurizing the fresh water;
a heater coupled for receiving and heating the pressurized fresh water;
a high pressure solution hose coupled for receiving the heated and pressurized fresh water;
a chemical source coupled for delivering a stream of cleaning chemical into the heated and pressurized fresh water within the high-pressure solution hose;
a carpet cleaner device coupled to the high pressure solution hose for receiving and dispersing the pressurized hot water and chemical cleaning solution to a target substrate;
a recovery tank for receiving soiled water and chemical cleaning solution;
a vacuum hose coupled to the carpet cleaner device for recovering the soiled water and chemical cleaning solution from the substrate via the carpet cleaner device and delivering the soiled cleaning solution to the recovery tank;
a vacuum blower coupled to produce a vacuum in the vacuum hose for recovering the soiled cleaning solution from the substrate; and
wherein the vacuum blower and the pressure generator are mechanically coupled to a power take-off output of the split shaft power take off unit.

11. The scanner cradle of claim 10, wherein the mobile vehicle further comprises a vehicle in any of Class 1, Class 2 or Class 3 as classified according to gross vehicle weight rating Department of Transportation's Federal Highway Administration (FHWA).

12. The scanner cradle of claim 10, wherein the vacuum generator and the pressure generator are mechanically coupled to the power take-off output of the split shaft power take off unit via a belt-and-pulley drive system.

13. The apparatus of claim 12, wherein a drive pulley is coupled to the power take-off output of the split shaft power take off unit.

14. The apparatus of claim 13, further comprising an auxiliary drive shaft coupled between the drive pulley and the power take-off output of the split shaft power take off unit.

15. The apparatus of claim 14, further comprising a drive shaft mount assembly coupled for supporting the auxiliary drive shaft.

16. A mobile carpet cleaning apparatus, comprising:
a mobile vehicle comprising an on-board power plant adjacent to a forward portion of the vehicle and mechanically coupled to a transmission, and a differential adjacent to a rearward portion of the vehicle;
a split shaft power take off unit positioned between the transmission and the differential, an input of the split shaft power take off unit being mechanically coupled through an input drive shaft to the transmission, and a straight-through output of the split shaft power take off unit being mechanically coupled through an output drive shaft to the differential;
a carpet cleaner system positioned in the vehicle, the carpet cleaner system comprising:
a conduit for receiving fresh water from a source thereof;
a pressure generator coupled for pressurizing the fresh water;
a heater coupled for receiving and heating the pressurized fresh water;
a high pressure solution hose coupled for receiving the heated and pressurized fresh water;
a chemical source coupled for delivering a stream of cleaning chemical into the heated and pressurized fresh water within the high-pressure solution hose;
a carpet cleaner device coupled to the high pressure solution hose for receiving and dispersing the pressurized hot water and chemical cleaning solution to a target substrate;
a recovery tank for receiving soiled water and chemical cleaning solution;
a vacuum hose coupled to the carpet cleaner device for recovering the soiled water and chemical cleaning solution from the substrate via the carpet cleaner device and delivering the soiled cleaning solution to the recovery tank;
a vacuum blower coupled to produce a vacuum in the vacuum hose for recovering the soiled cleaning solution from the substrate; and
wherein the vacuum blower and the pressure generator are mechanically coupled to a power take-off output of the split shaft power take off unit.

17. The scanner cradle of claim 16, wherein the vacuum generator and the pressure generator are mechanically coupled to the power take-off output of the split shaft power take off unit via a belt-and-pulley drive system.

18. The apparatus of claim 17, wherein a drive pulley is coupled to the power take-off output of the split shaft power take off unit.

19. The apparatus of claim 18, further comprising an auxiliary drive shaft coupled between the drive pulley and the power take-off output of the split shaft power take off unit.

20. The apparatus of claim 19, further comprising a drive shaft mount assembly coupled for supporting the auxiliary drive shaft.
